(19) United States
(12) Patent Application Publication
(10) Pub. No.: US 2016/0313904 A1
(43) Pub. Date: Oct. 27, 2016

(54) BUILDING CONTROL METHOD USING NETWORK MAP AND SYSTEM FOR SAME

(71) Applicant: SAMSUNG SDS CO., LTD., Seoul (KR)

(72) Inventor: Pyung Gil AHN, Seongnam-si (KR)

(73) Assignee: SAMSUNG SDS CO., LTD., Seoul (KR)

(21) Appl. No.: 15/103,615

(22) PCT Filed: Dec. 23, 2014
(86) PCT No.: PCT/KR2014/012686

§ 371 Date: Jun. 10, 2016

(30) Foreign Application Priority Data
Dec. 27, 2013 (KR) 10-2013-0165886

(51) Int. Cl. G06F 3/0484; F24F 11/00; H05B 37/02; G06F 3/0482; G06F 3/0481

(52) U.S. Cl. CPC G06F 3/04847; G06F 3/0482; G06F 3/04817; H05B 37/029; H05B 37/0245; F24F 11/006; G05B 2219/2614; F24F 2011/0061

(57) ABSTRACT

Disclosed are a building control method using a network map and a system for same. From a network map, in which at least one connection path directly connected to a central control point or connected by passing through at least one neighboring control point is attributed with a weight value, a building control server identifies a control point which satisfies a relation level or a weighted value included in control object information, and transmits a control command, when the control object information for selecting the control object control point from the network map transmitted by a user has been received.

### TECHNICAL FIELD

The present invention relates to a method and system for controlling various equipment in a building such as lightings and air conditioners, and more particularly, a building control method and system using a network map showing the connections between control points for controlling a controller.

### BACKGROUND ART

Conventionally, building control is performed in units of particular zones. For example, as illustrated in FIG. 1, in the case of controlling lightings in a building, a building control apparatus divides each floor into several zones, and controls the turning on or off of all lightings in each of the zones. Since building control is performed in units of zones, a problem arises in which lightings are turned on or off beyond the range desired by a user. In other words, in a case in which the user needs only some lightings in a “C” zone, all the lightings in the “C” zone are to be turned on, thereby resulting in waste of power.

### DISCLOSURE

### Technical Problems

To address the aforementioned problems, exemplary embodiments of the present invention provide a building control method and system using a network map, which are capable of not only performing control on physically fixed areas, but also dynamically setting and controlling control targets.

Exemplary embodiments of the present invention also provide a method and system for creating a network map to dynamically select control targets.

### Technical Solutions

According to an aspect of the present invention, a building control method includes: receiving control object information for selecting target control points from a network map in which a weight value is applied to each connection path between a central control point and at least one peripheral control point connected to the central control point either directly or via at least one other peripheral control point; identifying control points that satisfy a relation level or a weight value included in the control object information from the network map; and transmitting a command for controlling equipment in a building, or receiving and identifying particular values indicating a state of the equipment.

According to another aspect of the present invention, a method of creating a network map for controlling a building includes: displaying control point icons mapped to control points on a screen; receiving a setting of connection paths between the control point icons displayed on the screen from a user via a user input device; automatically allocating weight values to the connection paths by identifying information regarding control points mapped to control point icons at both ends of each of the connection paths from a database, or receiving a setting of weight values for the connection paths from a user; and storing a network map represented by the connection paths and the weight values in the database.

According to another aspect of the present invention, a building control server includes: a database including at least one network map, which is created based on information regarding at least one central control point and information regarding at least one peripheral control point connected to the central control point either directly or via at least one other peripheral control point; a reception unit receiving at least one of user identification information, user location information, and control point information; a map information identification unit searching for and finding a network map from the database based on at least one of the user identification information, the user location information, and the control point information; and a controller identifying control points corresponding to the control point information from the found network map and either transmitting a command for controlling equipment in a building, or receiving and identifying particular values indicating a state of the equipment.

According to another aspect of the present invention, a building control server using a network map, which consists of control points for controlling at least one equipment in a building or identifying particular values, includes: a map information setting unit displaying control point icons mapped to control points, respectively, and receiving a setting of connection paths between the control point icons displayed on the screen from a user; and a database storing a network map in which peripheral control point icons are connected to one control point icon either directly, or via at least one other control point icon, by the connection paths.

### BRIEF DESCRIPTION OF DRAWINGS

FIG. 1 is a schematic view illustrating a conventional lighting control method.

FIG. 2 is a schematic view illustrating a network map for controlling a building, according to an exemplary embodiment of the present invention.

FIG. 3 is a flowchart illustrating a building control method using a network map, according to an exemplary embodiment of the present invention.

FIGS. 4 through 8 are schematic views illustrating various examples of how to select target control points from a network map for controlling a building, according to an exemplary embodiment of the present invention.

FIGS. 9 through 11 are flowcharts illustrating building control methods using a network map, according to other exemplary embodiments of the present invention.

FIG. 12 is a schematic view illustrating a graphic interface for creating a network map for use in controlling a building, according to an exemplary embodiment of the present invention.

FIG. 13 is a schematic view illustrating a screen for mapping control point icons of FIGS. 12 to control points.

FIG. 14 is a schematic view illustrating a method of automatically setting a relation level and a weight value for each control point, according to an exemplary embodiment of the present invention.

FIG. 15 is a schematic view illustrating a method of controlling control points that are accessible by a user during the creation of a network map, according to an exemplary embodiment of the present invention.

FIG. 16 is a schematic view illustrating a server for controlling a building using a network map, according to an exemplary embodiment of the present invention.

FIG. 17 is a schematic view illustrating a database for storing a network map, according to an exemplary embodiment of the present invention.

FIG. 18 is a schematic view illustrating a system for controlling lightings using a network map, according to an exemplary embodiment of the present invention.

FIG. 19 is a flowchart illustrating a building control method using a network map, according to another exemplary embodiment of the present invention.

### BEST MODES FOR CARRYING OUT THE INVENTION

Advantages and features of the present invention and methods of accomplishing the same may be understood more readily by reference to the following detailed description of exemplary embodiments and the accompanying drawings. The present invention may, however, be embodied in many different provides and should not be construed as being limited to the embodiments set forth herein. Rather, these embodiments are provided so that this disclosure will be thorough and complete and will fully convey the concept of the present invention to those skilled in the art, and the present invention will only be defined by the appended claims. Like reference numerals refer to like elements throughout the specification.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and/or the specification and will not be interpreted in an idealized or overly formal sense unless expressly so defined herein. As used herein, the singular forms “a,” “an,” and “the” are intended to include the plural forms, including “at least one,” unless the content clearly indicates otherwise.

Building control methods and systems using a network map, according to exemplary embodiments of the present invention, will hereinafter be described with reference to the accompanying drawings.

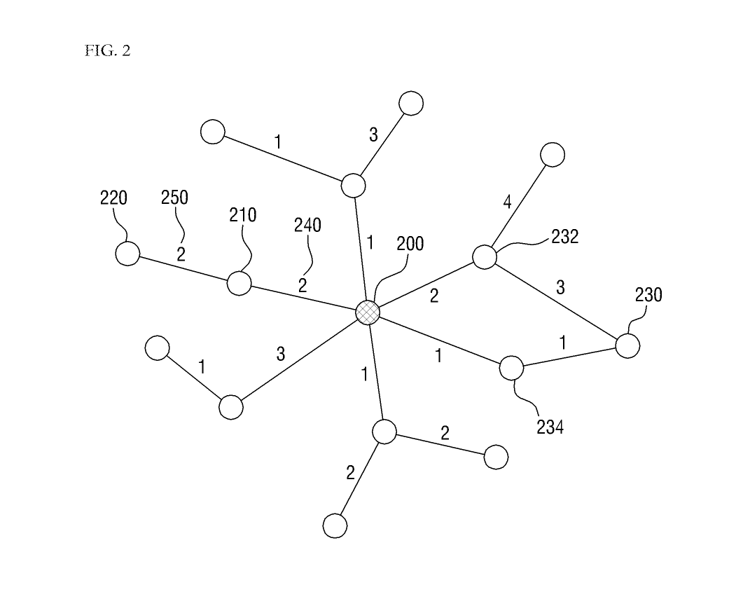

FIG. 2 is a schematic view illustrating a network map for controlling a building, according to an exemplary embodiment of the present invention. Referring to FIG. 2, circles 200, 210, 220, 230, 232, and 234 represent control points for controlling at least one controller. The control points receive a control command from a user, interpret the received control command, and transmit a control command (for example, a command to turn on/off lightings, change the intensity of illumination, or control particular values) needed by the controller. The controller is a device for directly controlling lightings or air conditioners, or controlling cooling and heating, and performs control operations according to the control command received from the control points.

The control points may be control points of the controller or sensing points for sensing particular values from equipment. That is, the control points may be points from which a building management system detects or controls particular values.

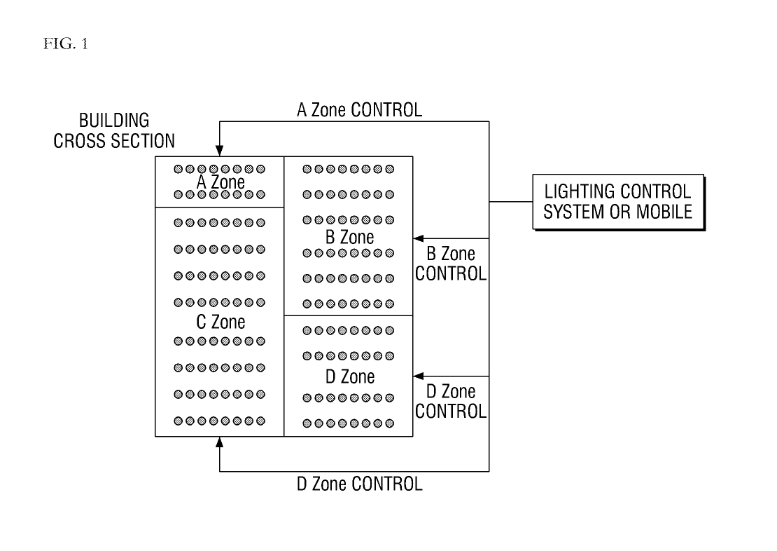

For example, the control points may be control points for controlling individual lightings illustrated in FIG. 1. According to the conventional lighting control method of FIG. 1, lightings are collectively controlled in units of physical spaces that are defined in advance, for example, “A” and “B” zones. However, in an actual use, the user may need only some lightings in the “A” zone to be turned on or may wish to change the intensity of illumination of some lightings in the “B” zone. According to the present invention, control points for controlling the individual lightings illustrated in FIG. 1 can be created, and thus, the lightings in the “A” zone can be collectively or individually turned on or controlled for their intensity of illumination by using a network map of the control points that can be dynamically created depending on the user's location. For such a dynamic control from the user's perspective, the present invention suggests a network map in which control points for controlling particular equipment or sensing points for detecting particular values from equipment are not fixed, but may vary dynamically depending on user location information.

A network map consists of a central control point 200, which is located at the center of the network map, and a plurality of peripheral control points 210, 220, and 230, which are located around the central control point 200. There exist the peripheral control point 210, which is connected directly to the central control point, and the peripheral control points 220 and 230 connected to the central control point via at least one other peripheral control point (i.e., at least one relay control point).

For convenience, the term “relation level” will hereinafter be used to describe the number of control points that need to be passed through to arrive at the central control point 200. For example, the peripheral control point 210, which is directly connected to the central control point 200, is defined as having a relation level of 1, and the peripheral control point 220, which is connected to the central control point 200 via one relay control point, i.e., the peripheral control point 210, is defined as having a relation level of 2. Weight values 240 and 250 are allocated to connection paths between the control points of the network map.

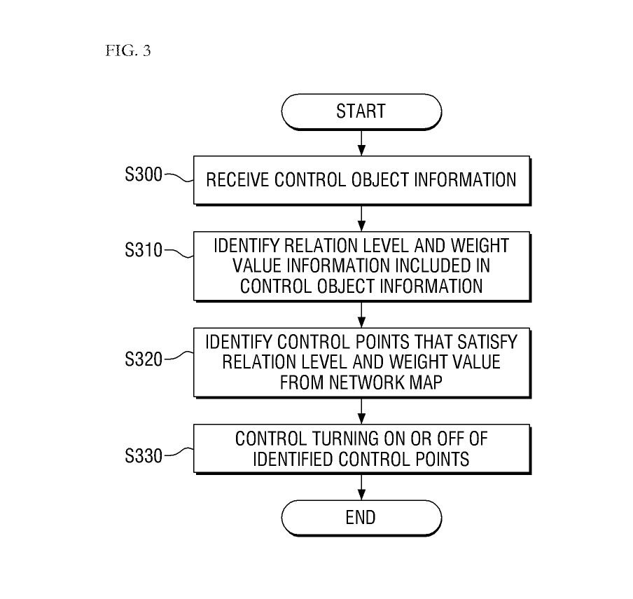

There may exist two or more connection paths between the control point 200 and the peripheral control point 230, and the connection paths may have different relation levels or weight values from one another. In a building control method illustrated in FIG. 3, relation level or weight value information is used to select target controls point to be controlled. Thus, if there are two or more connection paths, a particular one of the two or more connection path(s) needs to be selected.

As an exemplary method to select one of two or more connection paths, a connection path having a lower relation level and a smaller accumulated weight value than the other connection path(s) may be selected. Alternatively, a connection path having a higher relation level and a greater accumulated weight value than the other connection path(s) may be selected.

In a case in which a connection path selection method in which a connection path having a lower relation level and a smaller accumulated weight value than other connection paths is selected is applied to the example of FIG. 2, the two connection paths between the peripheral control point 230 and the central control point 200 both pass through only one control point 232 or 234 and have the same relation level of 2. Thus, referring to the two connection paths between the peripheral control point 230 and the central control point 200, the connection path that is located below the other connection path, i.e., the connection path having an accumulated weight value of 2 (=1+1), is selected. The connection path selection method is not particularly limited, and may vary from one exemplary embodiment to another exemplary embodiment of the present invention.

FIG. 3 is a flowchart illustrating a building control method using a network map, according to an exemplary embodiment of the present invention.

Referring to FIG. 3, a building control server receives control object information from a user terminal (S300). The building control server identifies relation level information and weight value information included in the control object information (S310), and identifies control points that satisfy the identified relation level information and weight value information from a network map (S320). Thereafter, the building control server controls particular values for controlling the turning on or off of equipment such as lighting equipment or for controlling hot water of a cooling and heating system and indoor temperature, or receives and identifies particular values (for example, cooling and heating temperatures and the indoor temperature) indicating the state of equipment via the identified control points, (S330) by transmitting a control command via the identified control points.

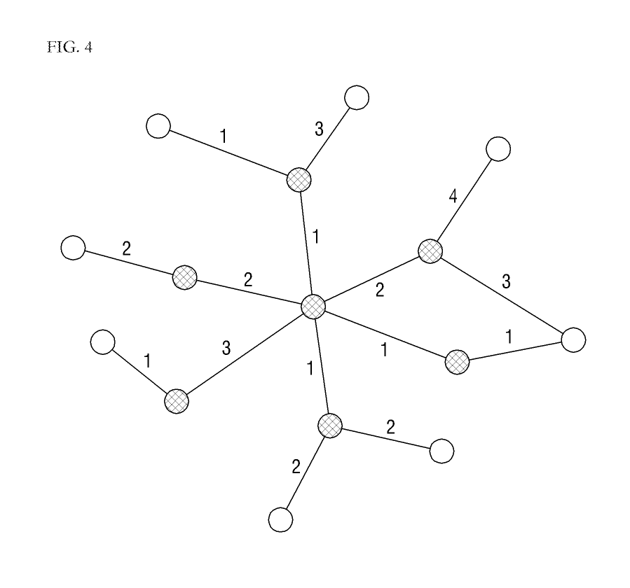

FIGS. 4 through 8 are schematic views illustrating various examples of how to select target control points from a network map for controlling a building, according to an exemplary embodiment of the present invention.

FIG. 4 illustrates an example in which control points having a relation level of 1 are selected as target control points. Referring to the network map of FIG. 4, peripheral control points directly connected to a central control point are selected from a network map as target control points (marked as shaded).

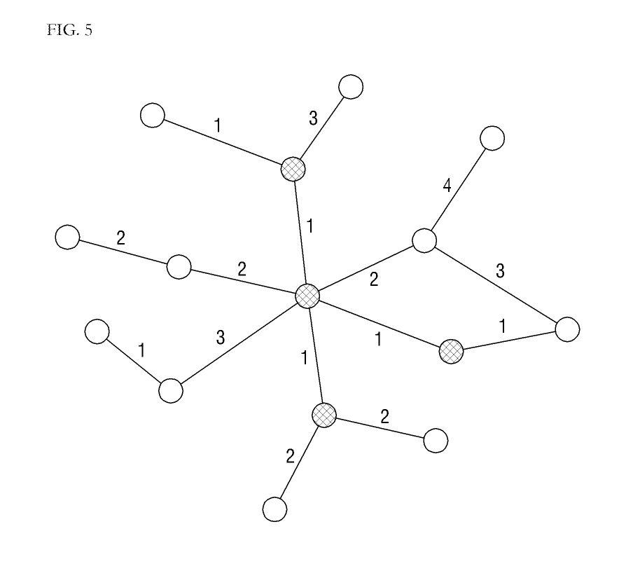

FIG. 5 illustrates an example in which control points having a relation level of 1 and a weight value of 1 are selected as target control points. Referring to the network map of FIG. 5, a central control point and peripheral control points directly connected to the central control point and having a weight value of 1 are selected as target control points (marked as shaded). On the other hand, peripheral control points directly connected to the central control point and having a weight value of 2 or 3 are not selected as target control points.

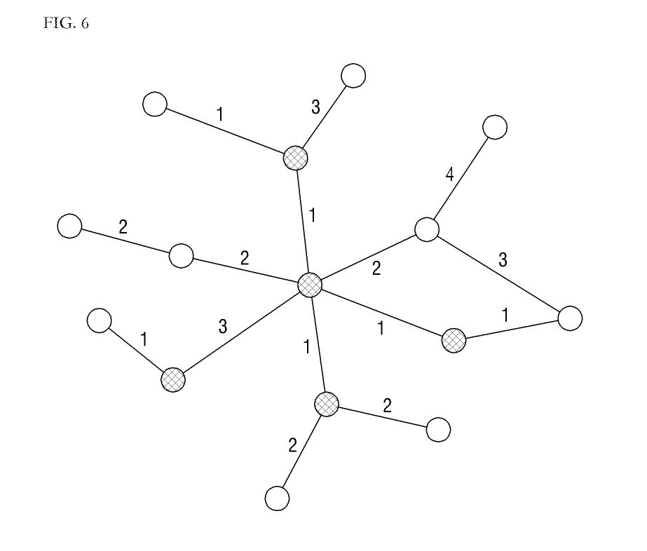

FIG. 6 illustrates an example in which control points having a relation level of 1 and a weight value of 1 or 3 are selected as target control points. Referring to the network map of FIG. 6, a central control point and peripheral control points directly connected to the central control point and having a weight value of 1 or 3 are selected as target control points (marked as shaded), but peripheral control points directly connected to the central control point, but having a weight value of 2, are not selected as target control points.

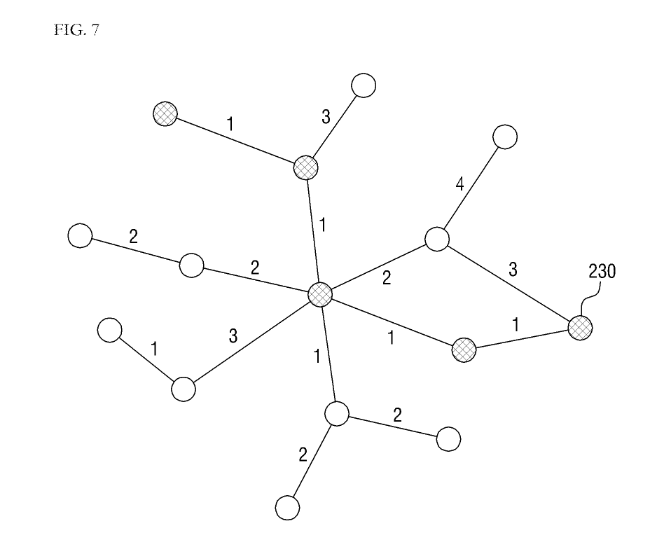

FIG. 7 illustrates an example in which control points having a relation level of 2 and a weight value of 2 or less are selected as target control points. Referring to the network map of FIG. 7, a central control point, peripheral control points having a relation level of 2 and an accumulated weight value of 2 or less, and all control points on the connection paths therebetween are selected as target control points (marked as shaded). In the case of the peripheral control point 230 having two connection paths to the central control point and having a relation level of 2, the lower connection path of the two connection paths is selected, as discussed above with reference to FIG. 2, and a determination is made as to which of the control points on the selected connection path should be selected as target control points based on their relation level and weight value.

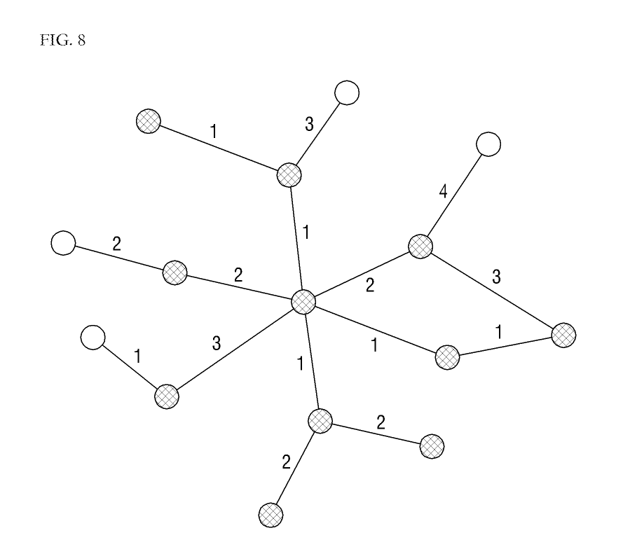

FIG. 8 illustrates an example in which control points having a weight value of 3 or less are selected as target control points. Referring to the network map of FIG. 8, all control points on connection paths having an accumulated weight value of 3 or less are selected as target control points (marked as shaded) regardless of their relation level.

The examples of FIGS. 4 through 8 are only exemplary, and target control points may be selected using various combinations of relation level information and weight value information, other than those set forth herein.

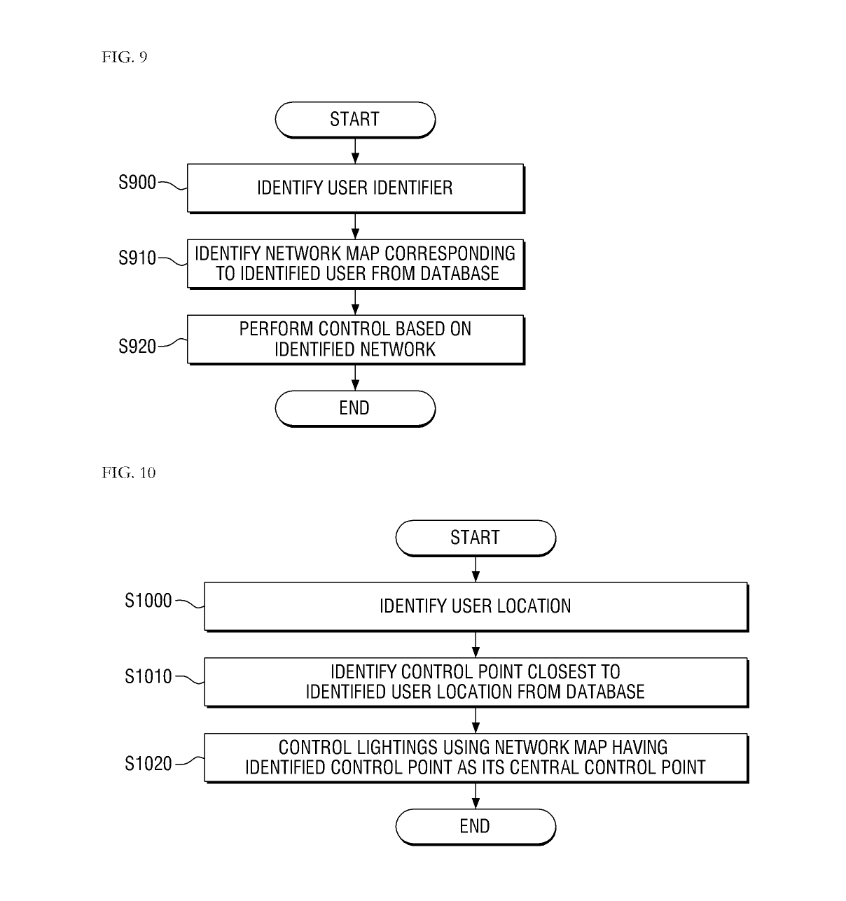

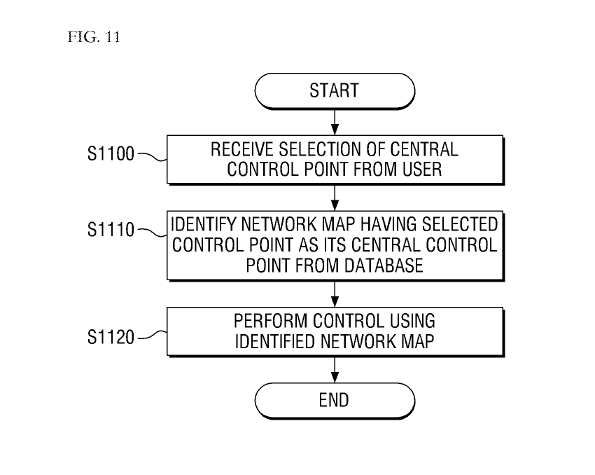

FIGS. 9 through 11 are flowcharts illustrating building control methods using a network map, according to other exemplary embodiments of the present invention. More specifically, FIG. 9 illustrates a building control method using a network map regarding a user's identifier, FIG. 10 illustrates a building control method using a network map regarding a user's location, and FIG. 11 illustrates a building control method using a network map having a particular control point as a central control point.

An intra-building network map may be created in various shapes as necessary, or depending on which control point is set as a central control point. With reference to FIGS. 9 through 11, it is assumed that there exist various network maps having various control points as their central control point in a database, and that the various network maps are each mapped to user identification information and location information.

Referring first to FIG. 9, a building control server receives user identification information from a user terminal (S900). Examples of the user terminal include various types of terminals (for example, a computer or a smartphone) that are connected to the building control server in a wired or wireless manner.

The building control server searches for and finds a network map mapped with user identification information from a database (S910). The building control server selects target control points from the found network map using the method described above with reference to FIG. 3, and controls the turning on or off of equipment, or controls or identifies particular values, through the selected target control points (S920).

Referring to FIG. 10, a building control server identifies a user's location (S1000). For example, the location of a user terminal may be identified using a plurality of access points (APs) disposed in a building. In response to an AP being accessed by the user terminal, the AP notifies the building control server of the user terminal's access, and the building control server identifies the location of the user terminal based on location information of the AP. Once the user's location is identified, the building control server searches for and finds a network map having a control point closest to the user's location as its central point from the database (S1010). Location information regarding the central control point of each network map is set in advance in the database.

The building control server selects target control points from the found network map using the method described above with reference to FIG. 3, and controls the turning on or off of equipment such as lighting equipment, or controls or identifies particular values for controlling, through the selected target control points (S1020).

Referring to FIG. 11, a user may choose a network map having a particular control point as its central control point. The building control method of FIG. 11 may generally be used in a case in which the user controls a building not from inside the building, or from a remote place, but the present invention is not limited thereto. That is, the building control method of FIG. 11 may also be used when the user is inside the building.

A building control server receives information regarding a particular control point from the user (S1100) and searches for and finds a network map having the particular control point as its central control point from a database (S1110). Then, the building control server selects target control points from the found network map using the method described above with reference to FIG. 3, and controls the turning on or off of equipment or particular values, or identifies measurement values for controlling, using the selected target control points (S1120).

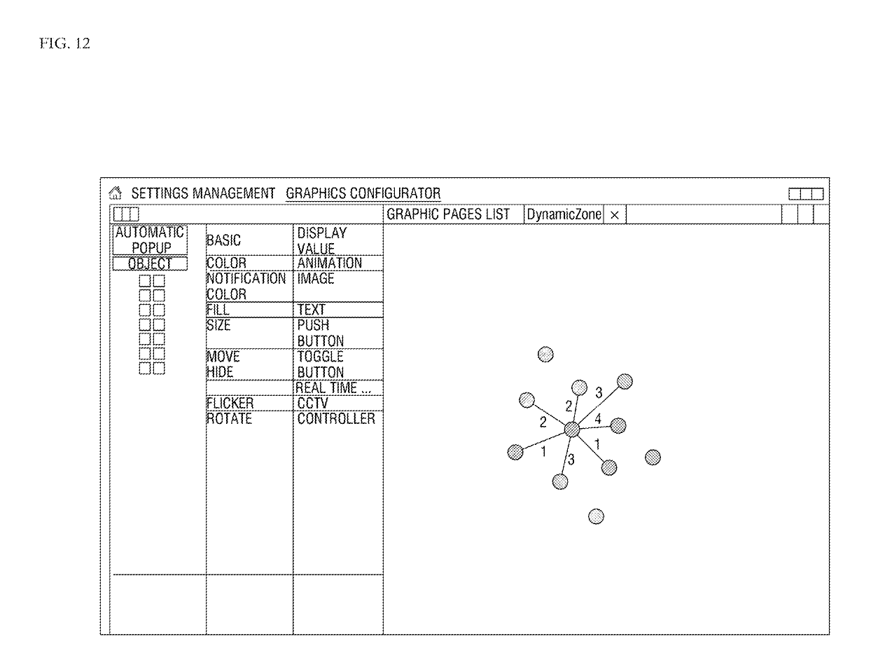

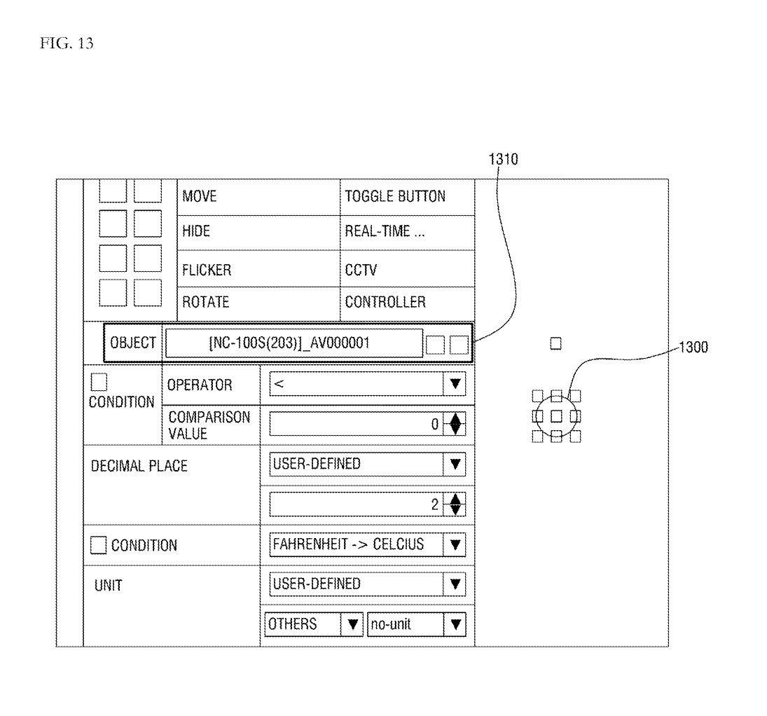

FIG. 12 is a schematic view illustrating a graphic interface for creating a network map for use in controlling a building, according to an exemplary embodiment of the present invention. FIG. 13 is a schematic view illustrating a screen for mapping control point icons of FIGS. 12 to control points.

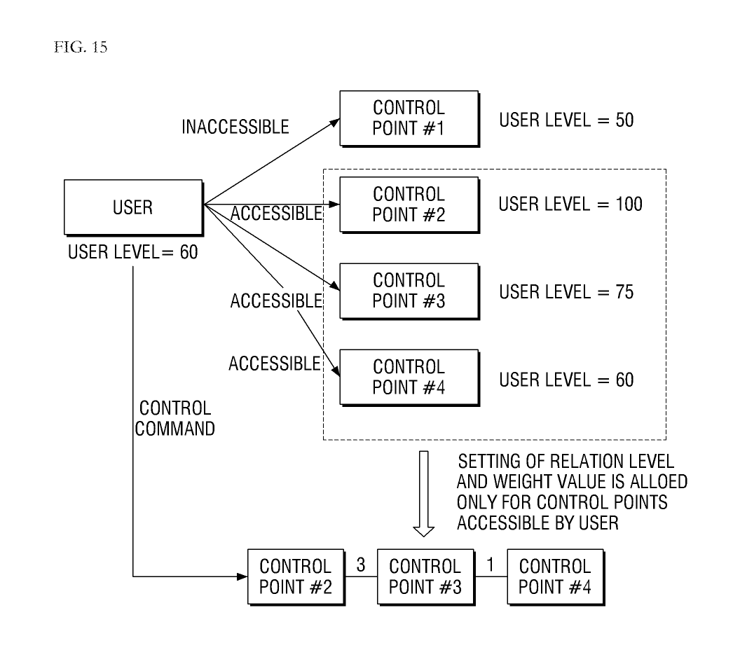

Referring to FIGS. 12 and 13, a building control server displays a plurality of control point icons to be mapped to control points on a screen. The control point icons may be mapped to control points by using attribute information as illustrated in FIG. 13. A user selects a control point icon 1300 and enters a selection of particular control point information 1310 to a control point information input window displayed on the left side of the screen. Control points that can be accessed to create a network map may be limited, and this will be described later with reference to FIG. 15.

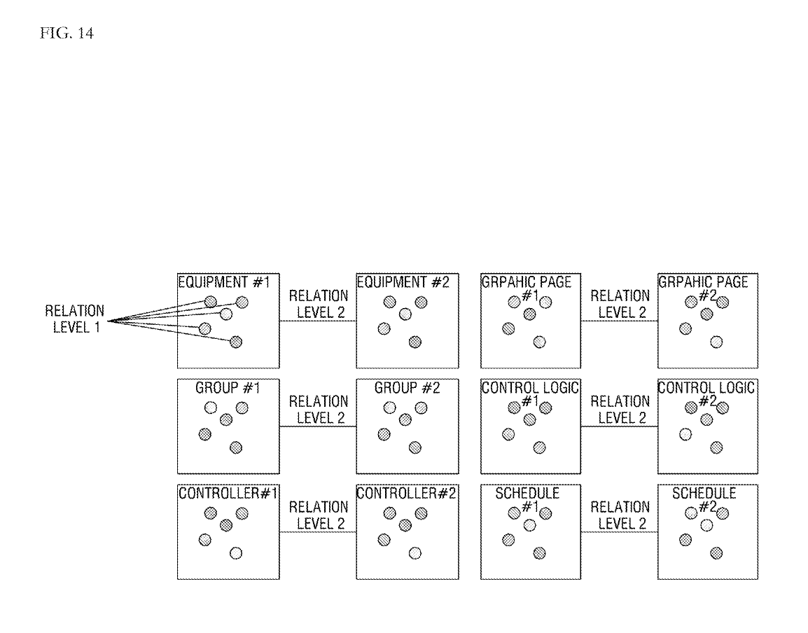

The user may set a connection relation between the control point icons displayed on the screen by using various user input devices such as a keyboard, a mouse, a touchscreen, or the like. Once connection paths are set between the control point icons, a weight value is allocated to each of the connection paths. The weight value may be entered directly by the user, or as illustrated in FIG. 14, a predefined weight value set in advance for each group may be automatically allocated to each of the connection paths.

FIG. 14 is a schematic view illustrating a method of automatically setting a relation level and a weight value for each control point, according to an exemplary embodiment of the present invention.

Referring to FIG. 14, control points may be classified into a plurality of groups according to the type of equipment to be controlled, the type of controller, and the type of schedule. For example, control points connected to a first lighting group may be classified into the same group, and control points connected to a second lighting group may be classified into the same group. Alternatively, control points connected to a controller for controlling lightings may be classified into the same group, and control points connected to a controller for controlling air conditioners may be classified into the same group. Control points may be classified according to various criteria, and may not necessarily belong to one group, but simultaneously to more than one group, according to various criteria.

Once control points are classified into groups, a relation level and a weight value may be set in advance for each of the groups, and the results of the setting may be stored in a database. Referring to FIG. 14, control points belonging to an “equipment #1” group may be set in advance to a relation level of 1, control points belonging to an “equipment #2” group may be set in advance to a relation level of 2, and a weight value may also be set in advance and stored in the database for each connection path between the control points belonging to the “equipment #1” group or the “equipment #2” group.

FIG. 15 is a schematic view illustrating a method of controlling control points that are accessible by a user during the creation of a network map, according to an exemplary embodiment of the present invention.

Referring to FIG. 15, each user is set to a predetermined level. Also, each control point is set to a predetermined level. Thus, a building control server identifies the level of a user who wishes to create a network map, and allows the user to create a network map by selecting control points that are determined to be accessible based on the identified level of the user and displaying the selected control points on the screen of FIG. 12.

For example, if the level of the user is 60 and the levels of control points 1, 2, 3, and 4 are 50, 100, 75, and 60, respectively, control points 2 through 4 are determined to be accessible by the user. Thus, the building control server displays control points 2 through 4 on the screen of FIG. 12, and the user creates a network map by setting connection relations among control points 2 through 4 and setting a weight value for each of the connection relations.

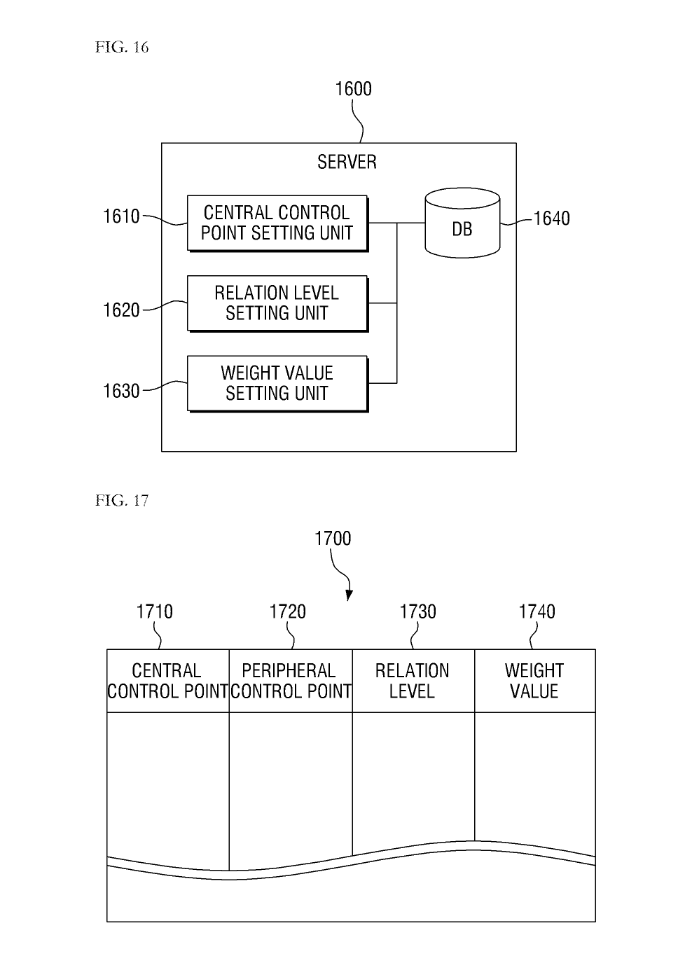

FIG. 16 is a schematic view illustrating a server for controlling a building using a network map, according to an exemplary embodiment of the present invention.

Referring to FIG. 16, a building control server 1600 includes a central control point setting unit 1610, a relation level setting unit 1620, a weight value setting unit 1630, and a database 1640.

The central control point setting unit 1610 receives a selection of a particular control point from among a plurality of control points as a central control point and registers the particular control point with the database 1640. The central control point setting unit 1610 may also store identification information and location information of the central control point and a mapping relationship that the central control point has with a particular user.

The relation level setting unit 1620 receives a setting of information such as relation level information regarding peripheral control points, which are connected to the central control point either directly or via at least one other peripheral control point, and stores the information in the database 1640. The weight value setting unit 1630 receives a setting of a weight value for each connection path between control points and stores the weight value in the database 1640.

The central control point setting unit 1610, the relation level setting unit 1620, and the weight value setting unit 1630 may receive a setting of necessary information from a user through a graphic interface screen as illustrated in FIG. 12, or may allow relation level or weight value information to be automatically set based on what control point belongs to which of the groups of FIG. 14, may display the set information on a screen, and may receive modified relation level or weight value information from the user.

FIG. 17 is a schematic view illustrating a database for storing a network map, according to an exemplary embodiment of the present invention.

Referring to FIG. 17, a database 1700 includes a central control point field 1710, a peripheral control point field 1720, a relation level field 1730, and a weight value field 1740.

The central control point field 1710 stores identification information of a central control point, and the peripheral control point field 1720 stores identification information of at least one peripheral control point connected to the central control point field. The relation level field 1730 stores a relation level that each peripheral control point has with regard to the central control point, and the weight value field 1740 stores weight value information regarding a weight value applied between the central control point and each peripheral control point.

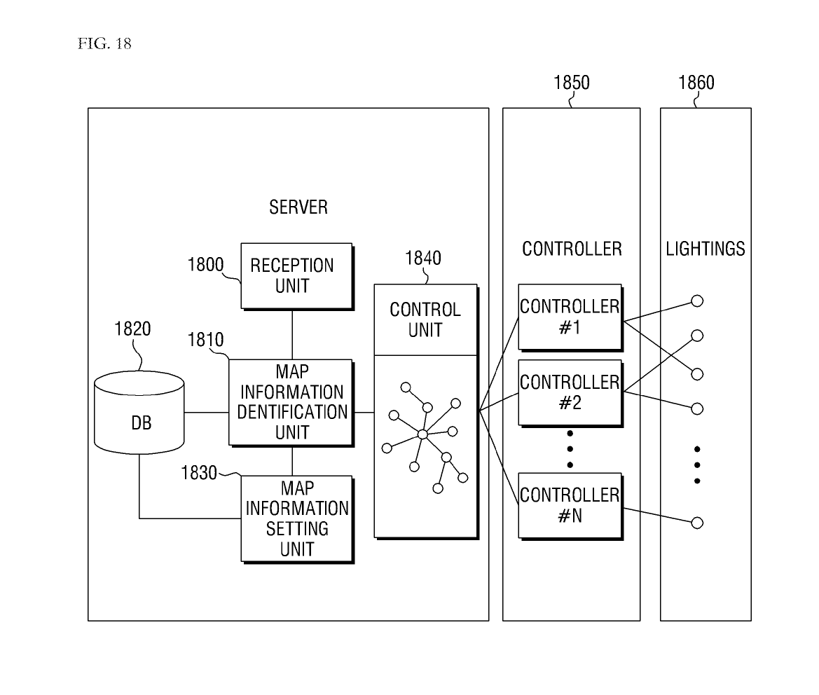

FIG. 18 is a schematic view illustrating a system for controlling lightings using a network map, according to an exemplary embodiment of the present invention.

Referring to FIG. 18, a building control server includes a user input unit 1800, a map information identification unit 1810, a database 1820, a map information setting unit 1830, and a control unit 1840. The building control server is connected to a controller 1850, which controls at least one lighting 1860, and the controller 1850 receives a control command via control points of a network map of the building control server, and either controls the turning on or off of the lightings or particular values or identifies a state value of equipment.

The user input unit 1800 receives user identification information, user location information, or particular control point information from a user to select a network map to be used in controlling a building. Also, the user input unit 1800 receives control object information from the user to select target control points from among the control points that exist in a network map.

The map information identification unit 1810 searches for and finds a network map that is mapped to the user identification information, the user location information, or the control point information from the database 1820. The control unit 1840 selects control points that satisfy the control object information received from the user from among the control points that exist in the found network map. Also, the control unit 1840 transmits a command for controlling equipment in the building via the selected control points, or receives and identifies particular values indicating the state of the equipment. A method to select the control points that satisfy the control object information is as described above with reference to FIGS. 3 through 9.

The map information setting unit 1830 provides a graphic interface as illustrated in FIG. 12 to the user, receives attribute information of each control point icon, connection relation information and weight value information between control points via the user input unit 1800, and stores the attribute information, the connection relation information, and the weight information in the database 1820. The map information setting unit 1830 may be implemented as illustrated in FIG. 16.

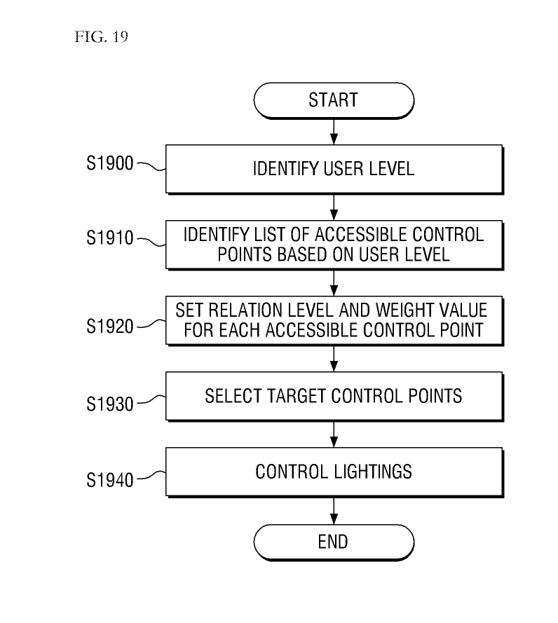

FIG. 19 is a flowchart illustrating a building control method using a network map, according to another exemplary embodiment of the present invention.

Referring to FIG. 19, in order to create a network map for controlling a building, a building control server identifies first a level allocated to a user (S1900). The building control server identifies control points that are accessible by the user based on the identified level and presents the accessible control points to the user (S1910). The building control server sets connection relations between the accessible control points and weight values for the connection relations, creates a network map consisting of a central control point and peripheral control points, and stores the network map (S1920). In response to control object information being received from the user who wishes to control particular equipment, the building control server searches for and finds target control points that satisfy relation level information and weigh information included in the control object information from the network map and presents the target control points to the user (S1930). The building control server transmits a control command via the target control points or identifies a state value of the particular equipment via the target control points (S1940).

The present invention may be realized by executing a computer program implemented in the form of computer readable code on a computer readable medium. The computer readable medium may be any type of recording medium on which data that can be read by a computer system can be stored. Examples of the computer recordable medium include a read-only memory (ROM), a random access memory (RAM), a compact disc (CD)-ROM, a magnetic tape, a floppy disk, and an optical data storage device. The computer readable medium can also be distributed over network-coupled computer systems so that the computer readable code may be stored and executed in a distributed fashion.

The computer program may be transmitted from a first computing device to a second computing device via a network such as the Internet and may then be installed and used in the second computing device. Examples of the first and second computing devices include stationary computing devices such as a server device, a desktop personal computer (PC), and the like, mobile computing devices such as a notebook computer, a smartphone, a tablet PC, and the like, and wearable computing devices such as a smart watch, smart glasses, and the like.

Exemplary embodiments of the present invention have been described with reference to the accompanying drawings. However, those skilled in the art will appreciate that many variations and modifications can be made to the disclosed embodiments without substantially departing from the principles of the invention. Therefore, the disclosed embodiments of the invention are used in a generic and descriptive sense only and not for purposes of limitation. The above-described embodiments of the present invention are presented for purposes of illustration and not of limitation.

What is claimed is:

1. A building control method, comprising:
receiving control object information for selecting target control points from a network map in which a weight value is applied to each connection path between a central control point and at least one peripheral control point connected to the central control point either directly or via at least one other peripheral control point;
identifying control points that satisfy a relation level or a weight value included in the control object information from the network map; and
transmitting a command for controlling equipment in a building, or receiving and identifying particular values indicating a state of the equipment.

2. The building control method of claim 1, wherein the relation level is a value corresponding to the number of other peripheral control points that exist on each connection path between the central control point and the at least one peripheral control point.

3. The building control method of claim 1, wherein the identifying the control points that satisfy the relation level or the weight value included in the control object information from the network map, comprises: if there exist at least two connection paths between the central control point and the at least one peripheral control point, selecting one of the at least two connection paths based on the number of control points that exist on each of the at least two connection paths, or based on a weight value of each of the at least two connection paths; and identifying control points that satisfy the control object information from among the control points that exist on the selected connection paths.

4. The building control method of claim 1, further comprising:
receiving user identification information, user location information, or control point information; and
searching for a network map from a database, which stores at least one network map in which a weight value is applied to each connection path between a central control point and at least one peripheral control point connected to the central control point either directly or via at least one other peripheral control point, based on the user identification information, the user location information, or the control point information.

5. The building control method of claim 4, wherein the receiving the user location information, comprises identifying the user location information based on the location of an access point (AP) accessed by a user terminal, among other APs disposed in the building, and the searching for the network map, comprises searching for a network map having a control point closest to the identified user location information as its central control point.

6. The building control method of claim 4, wherein the database includes information regarding at least one central control point, information regarding at least one peripheral control point connected to the at least one central control point, information indicating the number of relay control points that exist on each connection path between the at least one central control point and the at least one peripheral control point, and weight value information of each connection path between the at least one central control point and the at least one peripheral control point.

7. A method of creating a network map for controlling a building, the method comprising:
displaying control point icons mapped to control points on a screen;
receiving a setting of connection paths between the control point icons displayed on the screen from a user via a user input device;
automatically allocating weight values to the connection paths by identifying information regarding control points mapped to control point icons at both ends of each of the connection paths from a database, or receiving a setting of weight values for the connection paths from a user; and
storing a network map represented by the connection paths and the weight values in the database.

8. The method of claim 7, wherein the displaying comprises: identifying a level of the user; and
identifying control points that are accessible by the user by comparing the level of the user with levels of control points and displaying the identified control points on the screen.

9. The method of claim 7, wherein the database includes group information regarding each group to which control points belong among a plurality of groups classified according to at least one criterion including the type of equipment to be controlled, the type of control schedule method, and the type of controller and weight value information of connection paths between the connection points in each of the groups, and the receiving the weight value, comprises identifying group information and weight value information of the control points mapped to the control point icons at both ends of each of the connection paths from the database.

10. The method of claim 7, wherein the displaying comprises: displaying a plurality of control point icons on the screen; and
receiving a selection of a control point icon from the user and receiving control point information regarding a control point to be mapped to the selected control point icon.

11. A building control server, comprising:
a database including at least one network map, which is created based on information regarding at least one central control point and information regarding at least one peripheral control point connected to the central control point either directly or via at least one other peripheral control point;
a reception unit receiving at least one of user identification information, user location information, and control point information;
a map information identification unit searching for a network map from the database based on at least one of the user identification information, the user location information, and the control point information; and
a controller identifying control points corresponding to the control point information from the network map and either transmitting a command for controlling equipment in a building, or receiving and identifying particular values indicating a state of the equipment.

12. The building control server of claim 11, wherein in the at least one network map, a weight value is allocated to each connection path between the at least one central control point and the at least one peripheral control point, and the control object information comprises at least one of relation level information, which indicates the number of control points that exist between the central control point and the at least one peripheral control point, and weight value information of each connection path between the central control point and the at least one peripheral control point.

13. A building control server using a network map, which consists of control points for controlling at least one equipment in a building or identifying particular values, the building control server comprising:
a map information setting unit displaying control point icons mapped to control points, respectively, and receiving a setting of connection paths between the control point icons displayed on the screen from a user; and
a database storing a network map in which peripheral control point icons are connected to one control point icon either directly, or via at least one other control point icon, by the connection paths.

14. The building control server of claim 13, wherein the map information setting unit receives a weight value for each of the connection paths from the user, or extracts a predefined weight value for each connection relation between control points mapped to the control point icons, respectively, at both ends of each of the connection paths from the database and allocates the extracted weight value to each of the connection paths.

15. The building control server of claim 13, wherein the database maps at least one of user identification information of the user, physical location information of the control points, and identification information of the control points to the network map and stores the results of the mapping.

16. A computer-readable medium having recorded thereon a program for executing the steps of:
receiving control object information for selecting target control points from a network map in which a weight value is applied to each connection path between a central control point and at least one peripheral control point connected to the central control point either directly or via at least one other peripheral control point;
identifying control points that satisfy a relation level or a weight value included in the control object information from the network map; and
transmitting a command for controlling equipment in a building, or receiving and identifying particular values indicating a state of the equipment.
